(19) United States
(12) Patent Application Publication
(10) Pub. No.: US 2025/0298047 A1
(43) Pub. Date: Sep. 25, 2025

(54) PIPETTING DEVICE FOR PICKING UP AND/OR DISPENSING A PIPETTING HEAD

(71) Applicant: Integra Biosciences AG, Zizers (CH)

(72) Inventors: Erwin Halter, Chur (CH); Mirco Lareida, Flims (CH); Nicolas Boner, Chur (CH); Rafael Städler, Seewis-Schmitten (CH)

(21) Appl. No.: 19/084,063

(22) Filed: Mar. 19, 2025

(30) Foreign Application Priority Data
Mar. 20, 2024 (CH) CH000295/2024

(51) Int. Cl. G01N 35/04; G01N 35/10

(52) U.S. Cl. CPC G01N 35/04; G01N 2035/0474; G01N 2035/103

(57) ABSTRACT

A pipetting device which has a platform with a storage surface, a support device and a main unit arranged on the support device. The storage surface is intended for receiving laboratory containers. The main unit is arranged above the storage surface and has an opening at the bottom with a receiving device for receiving a pipetting head. The pipetting device is wherein the receiving device is movable relative to the storage surface in the three coordinate axis directions (X, Y, and Z).

### CROSS-REFERENCE TO RELATED APPLICATIONS

This application claims priority to Swiss Patent Application No. CH000295/2024, filed Mar. 20, 2024, the disclosure of this application is expressly incorporated herein by reference in its entirety.

### TECHNICAL FIELD OF THE INVENTION

The invention relates to a pipetting device for automatically receiving and/or dispensing a pipetting head, a pipetting head configured for such a pipetting device, a set comprising a pipetting device according to the invention and a pipetting head according to the invention, and a method for receiving a pipetting head by a pipetting device according to the invention.

### BACKGROUND TO THE INVENTION

Pipetting devices are intended to receive a pipetting head in order to use the pipetting head to pipette microtiter plates arranged on the pipetting device. To take a liquid from a reservoir and fill the containers of a microtiter plate with this liquid, the pipetting head must move in two directions, namely in the direction of height and width (Z and X axis direction). If the laboratory technician wants to fill the microtiter plate containers that are offset in the Y direction, the microtiter plate must be moved in the Y direction.

With pipetting devices used to date, the laboratory technician has to manually insert the pipetting head to be used. For this purpose, a door is arranged on the side of the pipetting device, through which the pipetting head can be inserted after opening it. At the same time, the door ensures that the pipetting head is secured in the pipetting device after closing. This procedure affects work in the laboratory negatively. The door is generally removable to make the insertion of the pipetting head as easy as possible while taking up as little space as possible. During this process, the door is placed on the work surface, again ensuring that the door is not contaminated. Inserting the pipetting head manually also carries the risk that the pipetting head may be inserted incorrectly into the pipetting device or damaged by the laboratory technician during the process.

### TASK

It is, therefore, a task of the present invention to propose a pipetting device, which can automatically receive and dispense a pipetting head while facilitating the complete pipetting of a microtiter plate.

### DESCRIPTION

The task is solved with a pipetting device for the automatic receiving and/or dispensing of a pipetting head according to the features of the independent claim.

The pipetting device comprises a platform having a storage surface, a support device, and a main unit arranged on the support device. The storage surface is intended for receiving laboratory containers. The main unit is arranged above the storage surface and has an opening at the bottom with a receiving device for receiving a pipetting head. The pipetting device is configured such that the pipetting head is received by inserting it into the opening in the main unit. For this purpose, the receiving device is movable in the three coordinate axis directions (X, Y, and Z) relative to the storage surface.

Due to the ability of the receiving device to move relatively in all three axis directions, it can independently pick up the pipetting heads from the storage surface. The pipetting heads do not need to be inserted into the receiving device by a user. This enables pipetting heads being picked up automatically by the receiving device. The opening at the bottom of the receiving unit leads to a simple setup of the receiving device to automatically receive pipetting heads.

In a preferred embodiment, the main unit projects from the support device in the Y direction and the main unit is movable in the Z and Y directions for receiving and/or dispensing the pipetting head. The Y direction forms the depth of the pipetting device. The support device and the main unit are preferably arranged side-by-side in the Y direction. Since the main unit is arranged above the storage surface, the support device can be arranged next to the storage surface. The main unit is intended to be moved in the Z and Y directions to receive and/or dispense a pipetting head. The movement of the main unit in at least two directions ensures a more reliable and reproducible receiving or dispensing of a pipetting head.

Preferably, the receiving device forms a form lock with the pipetting head. The ability of the receiving device to move enables it to form a form-locking connection with the pipetting head and enables the pipetting head to be moved to any position. The advantage of the form-locking connection is, among other things, that it does not require any additional tools and can therefore be generated quickly and subsequently also undone quickly.

The receiving device preferably comprises hook elements for forming the form-fitting connection. The hook elements form a structurally simple structure that enables the formation of a form-fitting connection. Therefore, it is sufficient for this purpose for the hook elements to move only in two of the three spatial axes.

In one embodiment, the receiving device comprises horizontally extending coupling elements configured to engage in a horizontal engagement direction with likewise horizontally extending coupling element counterparts of the pipetting head (such that the engagement provides a vertical lifting of the pipetting head by the receiving device) and/or be able to detach from these coupling element counterparts in the opposite direction. The receiving device is configured to carry out a movement in or against the horizontal engagement direction for receiving or releasing the pipetting head relative to the storage surface, whereby the coupling elements move along with the receiving device. The receiving device moves, for example, in that the receiving device moves along with a movement of the main unit. Alternatively or in combination with such a joint movement of the receiving device and the main unit, it is also conceivable that the receiving device can move relative to the main unit.

For example, each of the coupling elements is part of a hook element of the receiving device, wherein each of the hook elements comprises a leg extending in vertical direction towards the storage surface and the coupling elements extend in the horizontal engagement direction away from the leg.

In a further embodiment, the main unit comprises a locking element configured to assume a locking position and an open position. In the fixed position, a part of the locking element is, as opposed to the open position, located closer to or further in a spatial pipetting head area, which is occupied by the latter when the pipetting head is received. For example, this part of the locking element is intended to come into contact with the pipetting head or to block the range of movement of the pipetting head in the direction of the locking element. More generally, the locking element is intended to block the movement range of the pipetting head in at least one horizontal spatial direction, such that, for example, movement of the pipetting head in the engagement direction after the coupling elements have engaged with the coupling element counterparts is prevented or initially reversed and then blocked (so that by means of the interaction of the coupling elements, coupling element counterparts and the locking element, for example, a positive-locking reception of the pipetting head is provided in the receiving device).

For example, the portion of the locking element (which is in the fixed position closer to or further in the spatial area of the pipetting head than in the open position) is further away from the support device in the fixed position than in the open position and the horizontal engagement direction points toward the support device. Thus, the coupling elements for receiving the pipetting head move in the direction of the support device, whereby the movement of the pipetting head in the direction of the support device is blocked by the locking element.

Alternatively, the portion of the locking element is closer to or further in the area of the pipetting head in the fixed position in a horizontal direction transverse to the support device, and the horizontal engagement direction is towards to or away from the support device. With the pipetting head received in the main unit, the locking element thus engages the pipetting head in a claw-like manner from the left or right side in order to block movement of the pipetting head toward to or away from the support device, wherein the coupling elements for receiving the pipetting head have moved towards the support device.

In a further embodiment, the locking element is pre-tensioned into the fixed position and the main unit has a release component that is adjustable in the vertical direction relative to the receiving device. The main unit is further configured such that a vertical upward adjustment of the release component relative to the receiving device transitions the locking element from the fixed position to the open position. The release component is arranged such that it can be blocked by a blocking counterpart that is fixed relative to the storage surface during a vertical movement of the main unit towards the storage surface.

Consequently, the pipetting device may be configured to receive the pipetting head:
the main unit initially moves the direction of the storage surface until the locking element is transferred from the fixed position to the open position by a vertically upward adjustment of the release component relative to the receiving device,
then the receiving device is moved in the horizontal engagement direction, and
subsequently, the main unit carries out a lifting movement, in which the main unit is moved upwards in the direction away from the storage surface until the locking element, which is pre-tensioned into the fixed position, has moved back into the fixed position.

In a further embodiment, the receiving device comprises further horizontally extending coupling elements above the coupling elements, which are configured to engage in the horizontal engagement direction with further coupling element counterparts of the pipetting head, which also extend horizontally, and/or can detach from these further coupling element counterparts in the opposite direction. The further coupling elements are movable in a vertical direction relative to the coupling elements arranged below them. For example, this movement is carried out using the same drive provided in the pipetting device for providing the pipetting movement. Above the locking element, the main unit also comprises a further locking element, which is configured to assume a locking position and an open position, wherein a part of the further locking element is closer to or further in the area of the pipetting head in the fixed position compared to the open position. This further locking element is pre-tensioned into the fixed position and is transferred from the fixed position to the open position by a movement of the further coupling elements towards the coupling elements arranged below them. The further coupling elements can thus be moved independently of (e.g., before) the lifting movement of the main unit in a vertical direction away from the coupling elements arranged below them until the additional locking element, which has been pre-tensioned into its fixed position, has moved back into the fixed position.

For example, this separate lifting of an upper portion of the pipetting head is intended for the pipetting movement to fill the pipette tips of the pipetting head with a liquid by lowering the pipette tips for pipetting into a liquid, whereby pulling up the upper portion in the pipette tips creates a negative pressure and thus draws the liquid into the pipette tips.

In a further preferred embodiment, the support device projects upwards perpendicular to the storage surface. The vertical orientation of the support device with respect to the storage surface helps stabilizing the support device and with minimal material expenditure.

Preferably, the support device is arranged laterally on the storage surface. The arrangement of the support device close to the storage surface leads to a simpler construction of the support device and the main unit, since the main unit is arranged above the storage surface.

The pipetting device is advantageously designed as a benchtop device. The benchtop device is a device that is used in a laboratory and can be placed and operated on a workstation. A benchtop device can be transported from one place to another by a single person, resulting in a high level of flexibility when working in the laboratory.

For example, the pipetting device has a maximum mass of 30 kg. The limitation of the mass to 30 kg forms the limit below which the pipetting device can still be transported by a single person.

For example, the pipetting device has a maximum width of 1000 mm. The upper limit of the width of the pipetting device allows the pipetting device to operate on a limited work surface.

For example, the pipetting device has a maximum depth of 400 mm. The depth of the pipetting device is defined by the dimension perpendicular to the width and height.

Therefore, the depth of the pipetting device can determine how much the pipetting device will protrude away from a wall.

For example, the pipetting device has a maximum height of 600 mm. The height of the pipetting device is mainly determined by the support device. The height is, for example, limited to a maximum of 600 mm, since this achieves a compact design of the pipetting device while at the same time having sufficient space left for the pipetting head.

For example, the receiving device has a maximum deflection in the Y direction of 30 mm. The deflection in the Y direction is used to operate the entire width of the microtiter plate arranged on the pipetting device. To operate the entire microtiter plate, it is sufficient for the receiving device to move by 30 mm in the Y direction.

Advantageously, the main unit comprises a control element for controlling the movement of the main unit. The user can actively operate the control element. The user's movement on the control element is transferred to the main unit, which subsequently performs corresponding movements. The user can also enter an input to the control element to determine the movement of the main unit.

In a further preferred embodiment, an adapter is arranged on the storage surface for receiving laboratory containers. The adapter can be clamped onto the storage surface. The adapter offers the possibility to accommodate any type of container with the same pipetting device by changing the adapter. Therefore, the entire storage surface does not need to be replaced to accommodate different containers; simply replacing the adapter is sufficient.

For example, the storage surface and the adapter are configured such that the adapter is fixed on the storage surface in the X and Y directions and is configured to receive and fix the pipetting head in the X and Y directions. In particular, the adapter has the blocking counterpart for blocking the unlocking component when the main unit is moved toward the storage surface.

A further aspect of the invention relates to a pipetting head configured to be received in a pipetting device as described above. The pipetting head has a top and a bottom, a front and a back, and a right and a left side. For receiving it in the pipetting device, the front face of the pipetting device and the back face away from the pipetting device, the top face up and the bottom face down, and the left and right sides each face in directions transverse to the pipetting device.

According to this aspect, the pipetting head has on its left and right side, or on its front and back, each horizontally extending coupling element counterparts, that are configured to engage with matching horizontally extending coupling elements of the pipetting device and/or to disengage from the coupling elements of the pipetting device when the coupling elements move opposite the horizontal engagement direction.

For example, the coupling element counterparts are each provided by hook-shaped receiving elements arranged on the left and on the right side, or on the front and on the back side, wherein each of the hook-shaped receiving elements is formed by a leg opening open upwardly and extending in a vertical direction toward the bottom and an insertion opening extending horizontally away from said leg opening and closed at the top. For receiving the pipetting head in the pipetting device, the coupling elements can thus retract into the insertion openings by means of a first downward movement and a subsequent horizontal movement in the direction of engagement in order to lift the pipetting head.

In a further embodiment, the pipetting head has a top and a bottom part and is configured such that the top part is vertically movable away in upward direction relative to the bottom part. The coupling element counterparts are arranged on the bottom part and the top part comprises additional coupling element counterparts on its left and right sides, or on its front and back sides. Similar to the coupling element counterparts arranged on the bottom part, the additional coupling element counterparts arranged on the top part are configured, in order to engage additional coupling elements of the pipetting device that are aligned and move in the horizontal engagement direction or to disengage from the additional coupling elements of the pipetting device, when the further coupling elements move against the horizontal engagement direction.

For example, the further coupling element counterparts are also each provided by a leg opening that is open at the top and extends vertically towards the bottom and an insertion opening that extends horizontally away from said leg opening and is closed at the top.

In a further aspect, the invention relates to a set of a pipetting device according to the invention and a pipetting head as described above.

In particular, the pipetting device and the pipetting head are coordinated with one another in such a way that the pipetting device and the pipetting head form a positive connection when the coupling elements engage the coupling element counterparts and the locking element is simultaneously arranged in the fixed position, which thus provides for the pipetting head to be received in the pipetting device (and thus for the lifting and movement of the pipetting head by the pipetting device).

Preferably, the receiving device of the pipetting device comprises hook elements and the pipetting head comprises retaining elements, which together can form a form-fitting connection. The connection between the retaining and the hook elements is quickly generated and thereby increases the efficiency when working with a pipetting device according to the invention.

Preferably, the retaining elements are mounted laterally to the pipetting head. If the retaining elements on the pipetting head are arranged laterally, access to the pipetting head from above and below is still ensured without obstruction. At the same time, the retaining elements are thus maximally separated from each other, which in turn increases the stability when carrying a pipetting head.

The receiving and dispensing of the pipetting head is advantageously carried out via movement in the Z direction and one of the two other two axis directions. In order to perform a movement to hook the hook elements into the holding elements, the main unit must move in the Z direction. In addition, the movement in another direction perpendicular to this is sufficient.

In a further aspect, the invention also relates to a method for receiving a pipetting head by a pipetting device according to the invention, wherein the receiving device receives the pipetting head by a movement in two directions perpendicular to one another.

Preferably, one of these two directions is the Z-direction, which is directed perpendicular to the storage surface of the pipetting device.

### BRIEF DESCRIPTION OF THE FIGURES

The invention is described in more detail below with reference to the figures in a schematic presentation. Preferential features mentioned can be realized in any combination—for as long as they are not mutually exclusive. It shows in a non-scale, schematic representation:

FIG. 1: a three-dimensional view of a pipetting device;

FIGS. 2a and 2b: a side view of a pipetting device having a partial transparency in the area of the receiving device of the pipetting head, once with and once without the pipetting head received in the main unit;

FIGS. 3a, 3b, 3c and 3d: side views of the pipetting device as shown in FIG. 2a, whereby different temporal states are shown during the process of receiving a pipetting head in the main unit;

FIGS. 4a, 4b, 4c, 4d, 4e, 4f, 4g and 4h: further side views of the pipetting device as shown in FIGS. 2a to illustrate further details of the receiving process for receiving the pipetting head, wherein different temporal states are shown during the process for receiving the pipetting head in the main unit.

### DETAILED DESCRIPTION OF THE FIGURES

Hereinafter, the same reference symbols represent the same or functionally identical elements (in different figures). An additional apostrophe can serve to distinguish similar or functionally equivalent or functionally similar elements in a further embodiment.

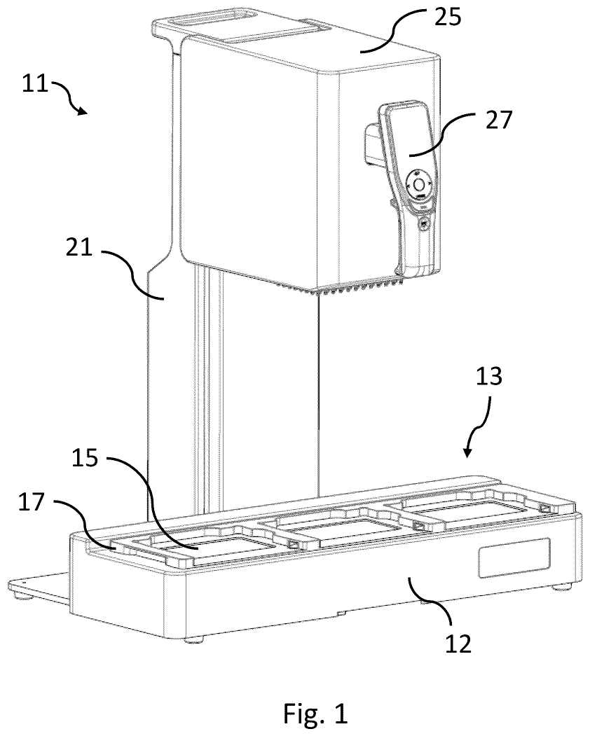

FIG. 1 shows a pipetting device 11, which comprises a storage device 12 with a storage surface 13. The storage device 12 has a cuboidal structure with a longitudinal side parallel to the floor. The largest surface of the storage device 12 is formed by the storage surface 13 and the surface opposite to it. In the embodiment shown in FIG. 1, the storage surface 13 comprises three clamping devices 15, which are arranged next to one another along the longitudinal direction. The clamping devices 15 have a rectangular-shaped base surface, which is surrounded on three of the four sides by an edge 17. The edge 17 separates the clamping devices 15 from one another and provides stability to the containers or microtiter plates placed on it.

A support device 21 is arranged on the side of the storage device 12, which projects vertically upward like a tower. A main unit 25 is in turn arranged on the support device 21. The main unit 25 is provided to receive a pipetting head. The pipetting head can receive pipette tips that can be inserted alternately into a container and microtiter plate to pipette a liquid. For this purpose, the main unit 25 can be moved up and down along the support device 21. The movement of the main unit 25 is triggered by the laboratory technician using a control element 27. The control element 27 is located on the front of the main unit 25 in the form of an elongated and vertically downward-facing control unit 27. The main unit 25 can be operated manually via the control element 27 or also automatically via a software or code stored in the main unit 25. The main unit 25 is also capable of being moved in the longitudinal direction of the storage surface 13. For this purpose, the support device 21 is designed to move together with the main unit 25 along the longitudinal direction of the storage surface 13. The main unit 25 is arranged on the front side of the support device 21 and is located above the storage surface 13. By moving in the longitudinal direction of the storage surface, the main unit can operate the storage surface's clamping devices arranged next to one another and the containers held therein.

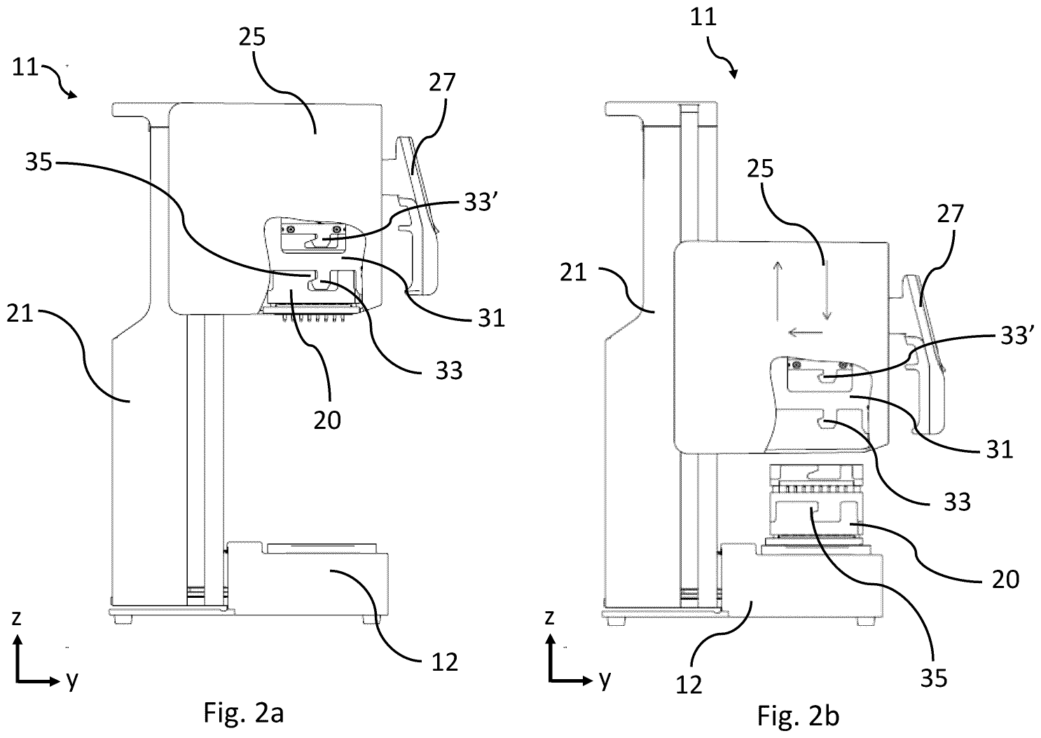

The main unit 25 is guided on the lateral surfaces of the support device 21. Thus, the front of the support device is closed by a smooth surface, which at the same serves as a clamping protection for the front of the support device. FIG. 2a shows a side view of the pipetting device 11 of FIG. 1. In the main unit 25, a part of the side wall is designed transparently so that it is possible to view the interior of the main unit 25. The transparent part of the main unit 25 comprises a receiving device 31 for a pipetting head 20, wherein in the figure a pipetting head 20 is received by the receiving device 31 of the main unit. The main unit 25 is located at the highest position on the support device 21 and thus has the greatest possible distance from the storage surface 13. The upward movement of the main unit 25 is mechanically limited due to the guides on the lateral surfaces of the support device 21. The receiving device 31 of the main unit comprises two hook elements 33, 33′ each arranged on top of the other. The hook elements 33 each have a curved hook, which has a bend in the Y direction, so that the opening of the hook is directed in the Y direction or toward the support device 21. It is important that the opening of the two hooks each arranged on top of the other is directed in the same direction. In the embodiment shown in FIG. 2, the hooks are each arranged on top of the other such that they have approximately the same distance from the support device 21.

The receiving device 31 of the main unit of a pipetting device according to the invention is able of being moved in the Y direction. The movement of the receiving device 31 can be controlled via the control element 27 of the main unit or can be carried out automatically by a program pre-stored in the main unit. In the embodiment shown in FIG. 2, the movement of the receiving device 31 is caused by the relative movement of the receiving device 31 relative to the main unit 25. Alternatively, the main unit 25 may be moved in the Y direction, thereby also moving the receiving device 31 therein in the Y direction.

Movement in the Y direction, in combination with the hook elements 33 on the receiving device 31, allows the receiving of pipetting heads 20 into the main unit 25. The pipetting head 20 to be received comprises laterally arranged retaining elements 35, which can each form a releasable connection with the hook elements 33 of the receiving device. Ideally, a snap-in closure occurs, which is generated by the weight of the pipetting head 20.

FIG. 2b shows the pipetting device 11 with an empty main unit 25. The pipetting head 20 to be received by the main unit is placed on the support surface. Through a movement sequence, as shown by three arrows in the Figure, the receiving device 25 can receive the pipetting head 20.

The process for receiving and dispensing the pipetting head 20 by the main unit 25 can be carried out automatically. Based on the information contained in the main unit 25, the main unit 25 determines how large the deflection in the Y direction must be in order to receive the respective pipetting head 20.

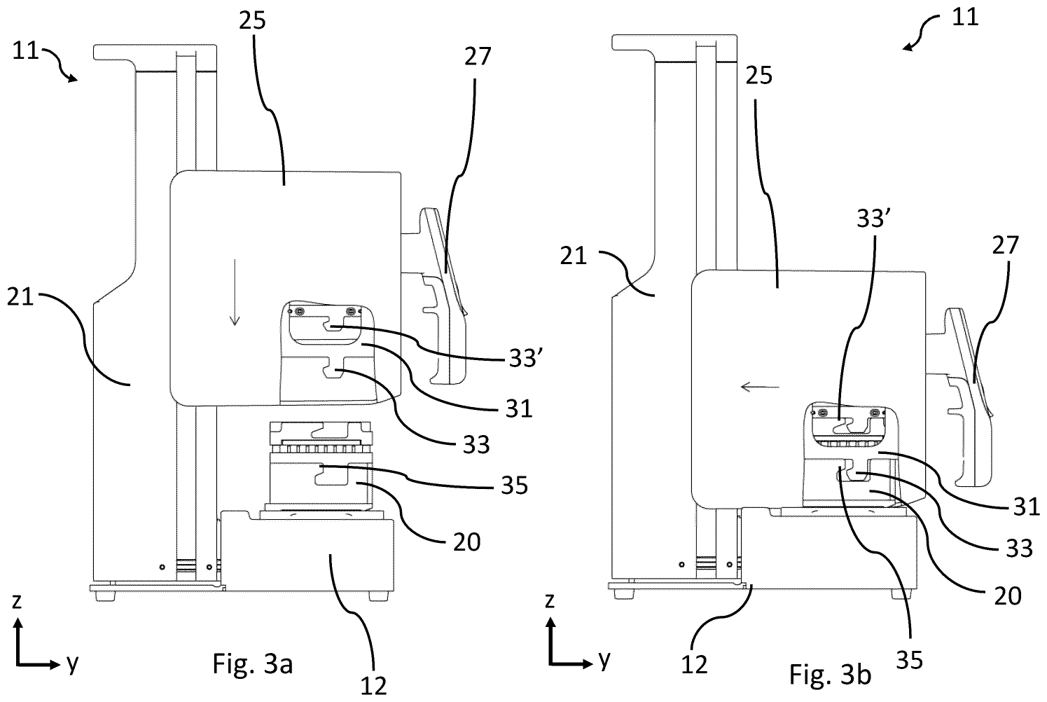

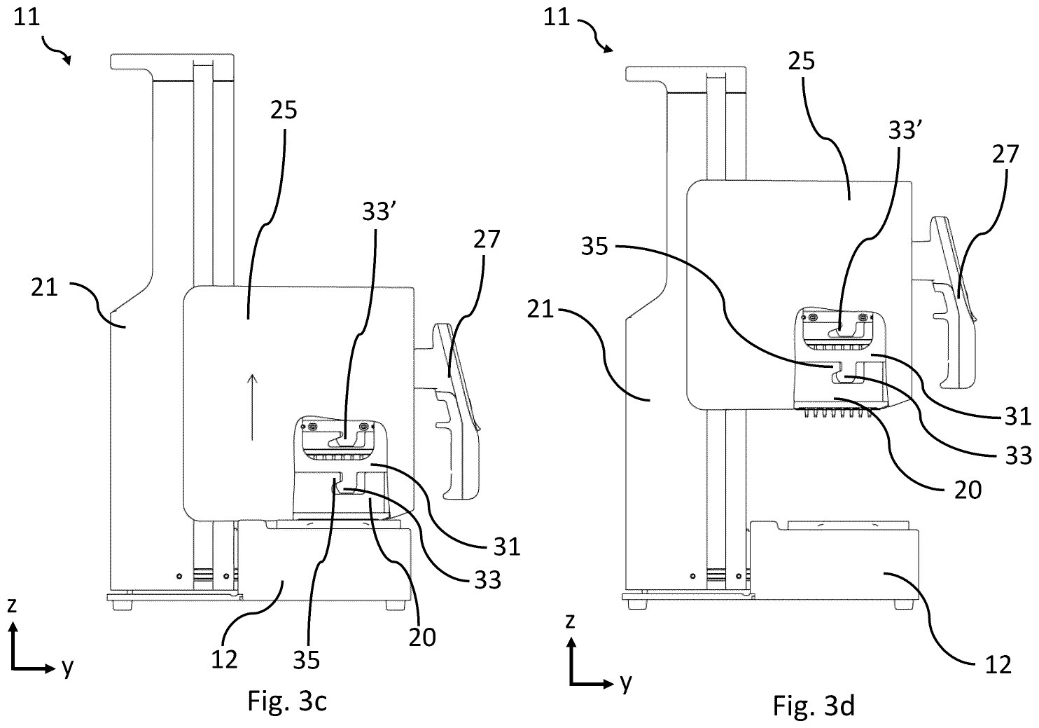

In FIG. 3, the process for receiving a pipetting head 20 is explained step-by-step below:
In the initial position, the pipetting head 20 is placed in the clamping device 15 on the storage surface 13 of the storage device 12. The main unit 25 of the pipetting device 11 is located above the pipetting head 20. At most, the main unit 25 must be moved along the longitudinal side of the storage surface 13 so that the main unit 25 is positioned exactly above the pipetting head 20 to be received.
To receive the pipetting head 20, the main unit 25 must move downward and forward and backward in the Y direction, see FIG. 3a. The forward movement in the Y direction, i.e., away from the support device 21, can be carried out before or simultaneously with the downward movement. It is important that the forward movement in the Y direction is completed before the main unit 25 reaches the pipetting head 20.
At the lowest position of the main unit 25, the pipetting head 20 is already inserted in it. By moving the main unit 25 towards the support device 21 as shown in FIG. 3b, the hook elements 33 of the receiving device 31 engage the retaining elements 35 of the pipetting head 20. By moving the main unit 25 upward as shown in FIG. 3c, a form lock is established between the hook elements 33 and the retention elements 33 and as a result, the pipetting head 20 is connected to the main unit 25 and moves with the main unit.
The main unit 25 of FIG. 3d can start the pipetting process with the pipetting head 20 inserted in it. For this purpose, the pipetting head 20 can be moved in all three axis directions, whereby the pipetting head 20 is always above the storage surface 13.
To dispense the pipetting head 20, the main unit 25 is positioned above a clamping device 15 of the storage surface 13, so that after a downward movement of the main unit 25, the pipetting head 20 comes to rest on the storage surface 13 and in a clamping device 15. After the pipetting head 20 rests on the support surface 13, the receiving device 31 can be moved forward in the Y direction, whereby the hook element 33 of the receiving device 31 is removed from the retention element 35 of the pipetting head 20 and at the same time the connection between the two components is released. The receiving device 31 is then ready to receive another pipetting head 20.

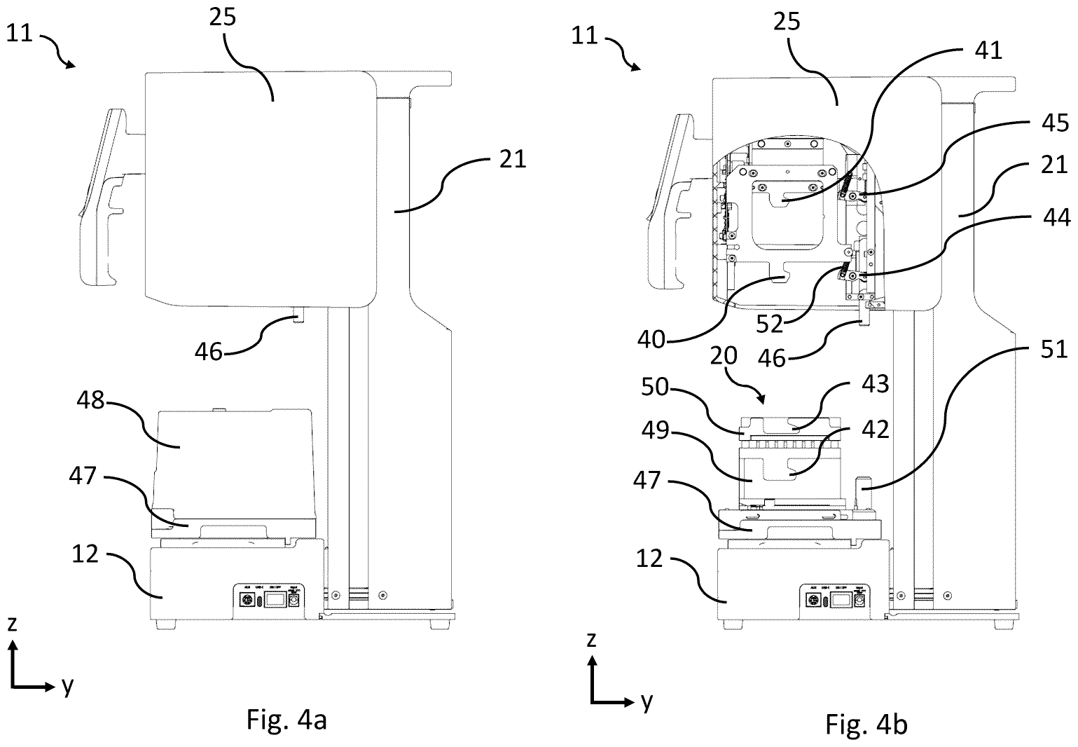

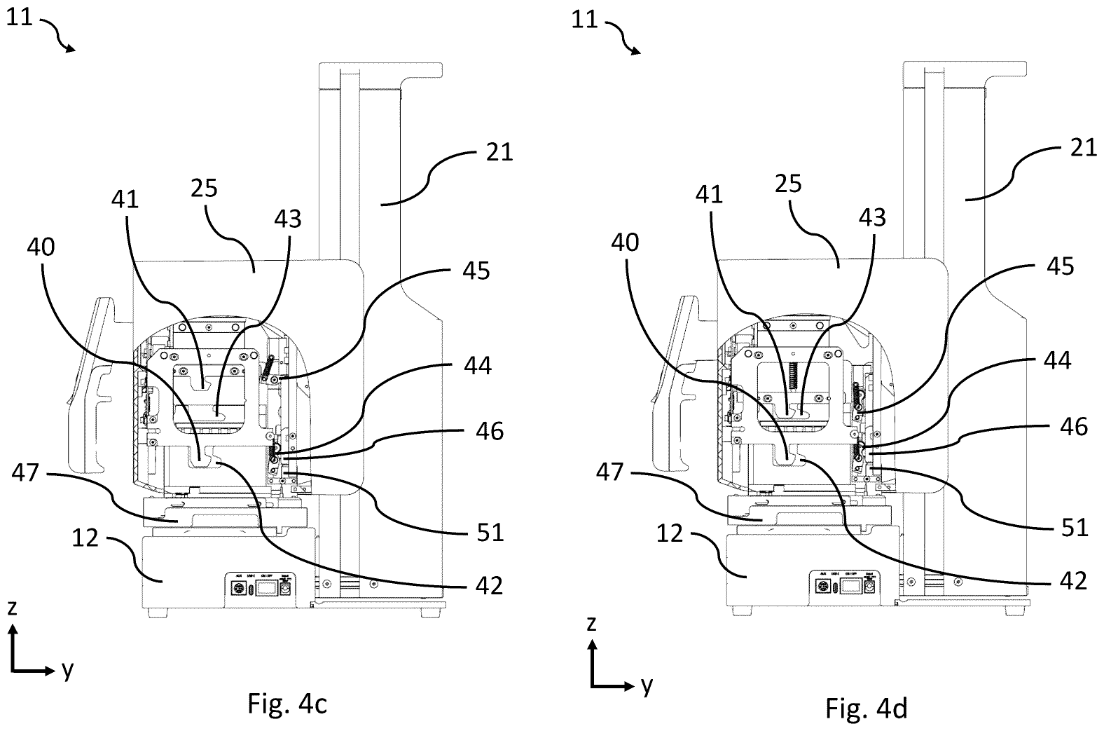

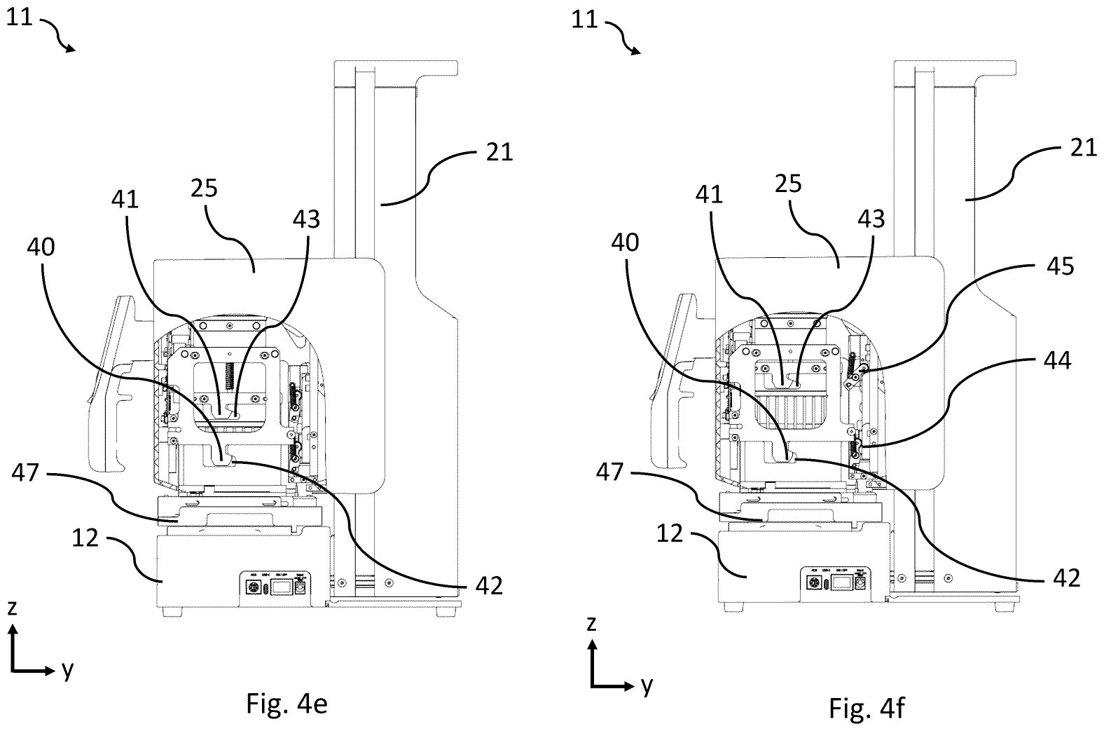

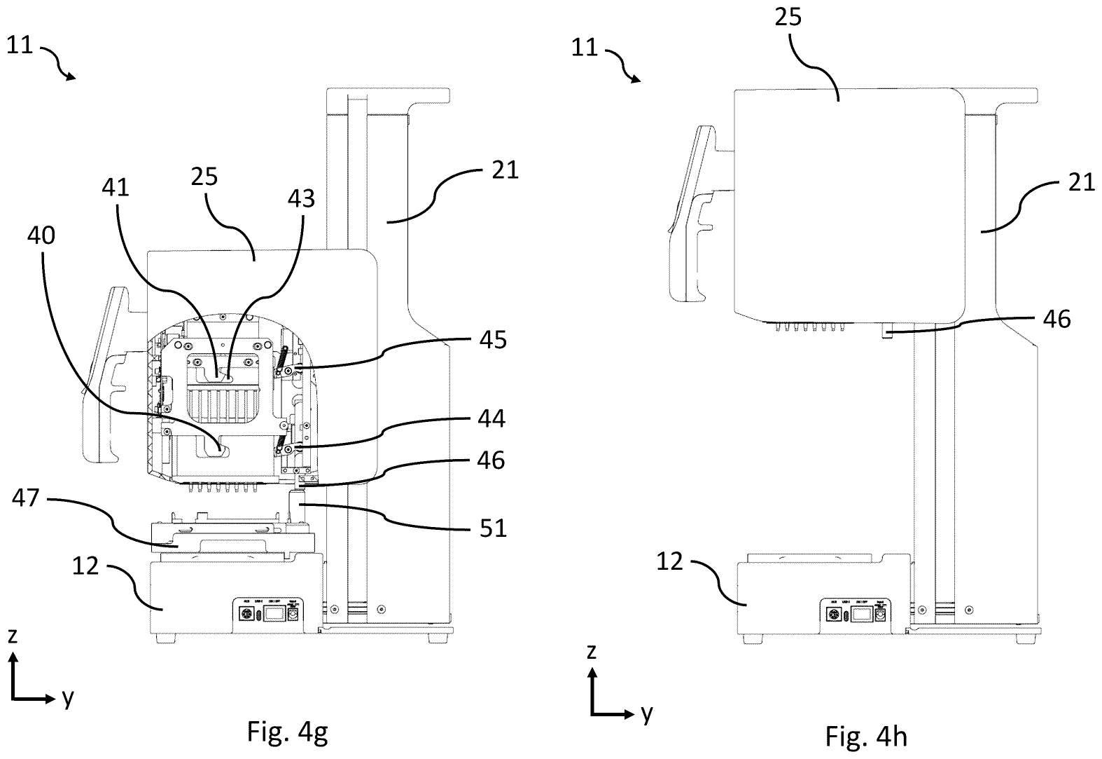

FIGS. 4a to 4h again show in more detail the above-described embodiment of the pipetting device 11 and the pipetting head 20 as well as a potential embodiment of the coupling elements 40, 41, coupling element counterparts 42, 43, locking elements 44, 45, and releasing component 46.

FIG. 4a shows a side view of the pipetting device 11 as previously described, wherein a pipetting head 20 is arranged on the storage device 12 for being inserted in the pipetting device 11. The pipetting head 20 is arranged in an adapter 47 configured in such a way to interact with the storage device 12 such that movement of the adapter 47 in the Y direction is blocked. The adapter 47 in turn blocks a movement of the pipetting head 20 accommodated in it in the Y direction.

As shown in the Figure, the adapter 47 may be combined with a cover 48 such that when the cover 48 is placed on the adapter 47, the pipetting head 20 is completely enclosed by the adapter 47 and the cover 48. Thus, the removed pipetting head 20 can be safely stored and transported. For example, the cover 48 and/or the adapter 47 is configured such that multiple such adapter-cover-pipetting head combinations can be stacked on top of each other for storage or transport. In particular, adapter 47 and lid 48 are shaped and aligned to one another in such a way that when stacked on top of each other they form a positive connection so that at least mutual movement in the X and Y directions is prevented.

As shown in FIG. 4b, the cover 48 is first removed to receive the pipetting head 20 in the pipetting device 11. In the figure, a part of the side wall of the main unit 25 is designed to be transparent as to enable a view into the interior of the main unit 25.

The pipetting head 20 has a lower part 49 and an upper part 50 and is configured such that the upper part 50 can be moved upwards relative to the lower part 49 for pipetting pipette tips of the pipetting head 20. Both upper and lower parts have coupling element counterparts 42, 43 on the left and right side, hereinafter referred to as lower coupling element counterparts 42 and upper coupling element counterparts 43 (previously also referred to as coupling element counterparts and further coupling element counterparts arranged above them). In the embodiment shown, the lower and upper coupling element counterparts 42, 43 are each provided with hook-shaped receptacles, each of the hook-shaped receptacles being formed by a leg opening that is open upwards and extends in a vertical direction toward the underside and an insertion opening that extends away from said leg opening in a horizontal direction and is closed at the top.

The main unit 25 comprises the receiving device described above. This comprises lower coupling elements 40 and upper coupling elements 41 matched to the lower and upper coupling element counterparts 42, 43 (previously also referred to as coupling elements and further coupling elements arranged above them). In the embodiment shown, each of the lower and/or upper coupling elements 40, 41 is/are part of a hook element of the receiving device, wherein each of the hook elements comprises a leg extending in vertical direction towards the storage surface and the lower and/or upper coupling elements 40, 41 extend in the horizontal engagement direction away from the leg (here towards the support device 21).

For receiving the pipetting head 20 in the pipetting device 11, the coupling elements 40, 41 can thus retract into the insertion openings by means of a first downward movement and a subsequent horizontal movement (here toward the support device 21) in the direction of insertion openings in order to lift the pipetting head 20.

Furthermore, the figure also shows a release component 46 projecting from the bottom of the main unit 25, which is arranged such that when the main unit 25 is lowered, it encounters and is blocked by a blocking counterpart 51 provided by the adapter 47 in the embodiment shown.

In addition, lower and upper locking elements 44, 45 of the receiving device respectively arranged in the main unit 25 are shown (previously also referred to above as locking element and further locking element arranged above it). The figure shows both locking elements 44, 45 arranged in the fixed position. Each of the locking elements 44, 45 is provided here, for example, by means of a pin mounted so as it can rotate about an axis of rotation, wherein the axis of rotation is parallel to the X direction and the pin is pre-tensioned to the fixed position with a spring element 52. In the fixed position, the longitudinal axis of the pin is oriented horizontally as shown in the figure. In the open position, the longitudinal axis of the pin is vertically aligned as shown in FIG. 4d.

In FIG. 4c, the main unit 25 has been lowered toward the storage device 12 via the pipetting head 20, wherein the further downward movement of the unlocking component 46 was blocked by contact with the blocking counterpart 51 of the adapter 47 such that the unlocking component 46 has moved upward relative to the receiving device. This movement of the release component 46 in turn has transitioned the lower locking element 44 from the fixed position to the open position. In the embodiment shown, this was accomplished by the release component 46 acting on the rear portion of the pin of the lower locking element 44, thereby causing the pin to rotate about its axis of rotation into a vertical orientation of the pin.

FIG. 4d shows as a further step a lowering of the upper coupling elements 41, e.g., by means of the drive provided for the pipetting movement. A further unlocking component, which moves with the vertical movement of the upper coupling elements 41, has acted on the front part of the pin of the upper locking element 45 and thus caused the pin to rotate about its axis of rotation into a vertical orientation of the pin.

FIG. 4e shows, as a further step a horizontal movement of the receiving device towards the support device 21, whereby the lower and upper coupling elements 40, 41 have engaged with the lower and upper coupling element counterparts 42, 43.

FIG. 4f initially shows as a further step a lifting of the top part of the pipetting head, whereby the further release component releases the pin of the upper locking element 45 and the upper locking element 45 moves back to the pre-tensioned fixed position.

FIG. 4g shows the situation after the main unit 25 has been lifted to the point that the release component 46 of the lower locking element 44 has disengaged from the blocking counterpart 51 of the adapter 47, so that the lower locking element 44 has also moved back to its pre-tensioned fixed position.

By engaging the coupling elements 40, 41 in the coupling element counterparts 42, 43 and the locking elements 44, 45 arranged simultaneously in the fixed position, the pipetting head is now positively received in the main unit 25 and can be moved back and forth by the latter for pipetting in X and Z directions. For this purpose, as shown in FIG. 4h, the adapter 47 is removed from the storage device 12 so that a container containing a liquid and a microtiter plate can be arranged on the storage surface (not shown).

While specific embodiments have been described above, it is obvious that different combinations of the embodiments shown may be used, provided the embodiments are not mutually exclusive.

### List of Reference Symbols

11 Pipetting device

12 Storage device

13 Storage surface

15 Clamping device

17 Edge of clamping device

20 Pipetting head

21 Support device

25 Main unit

27 Operating unit

31 Receiving device

33 Hook element

35 Retention element

40 Lower coupling element

41 Upper coupling element

42 Lower coupling element counterpart

43 Upper coupling element counterpart

44 Lower locking element

45 Upper locking element

46 Release component

47 Adapter

48 Cover for adapter

49 Lower part of the pipetting head

50 Upper part of the pipetting head

51 Blocking counterpart

52 Spring element

1.-15. (canceled)

16. A pipetting device for automatically receiving and/or dispensing a pipetting head, wherein
the pipetting device comprises a platform with a storage surface, a support device and a main unit arranged on the support device,
the storage surface is provided for receiving laboratory containers, and
the main unit is arranged above the storage surface, wherein
the main unit has an opening on the lower side with a receiving device for receiving a pipetting head, wherein the pipetting device is configured such that the pipetting head is received by insertion through the opening in the main unit, for which the receiving device is movable relative to the storage surface in the three coordinate axis directions (X, Y and Z).

17. The pipetting device according to claim 16, wherein the main unit protrudes from the support device in the Y direction and the main unit is movable in the Z and Y directions for receiving and/or dispensing the pipetting head.

18. The pipetting device according to claim 16, wherein the receiving device is designed to provide the receiving of the pipetting head by means of a form lock, in particular wherein the receiving device comprises hook elements for forming the form lock.

19. The pipetting device according to claim 16, wherein the receiving device comprises horizontally extending coupling elements, that are configured such that they can engage in a horizontal engagement direction with likewise horizontally extending coupling element counterparts of the pipetting head or can detach from these coupling element counterparts in the opposite direction, wherein the receiving device is configured to carry out a movement in or against the horizontal engagement direction for receiving or releasing the pipetting head relative to the storage surface, wherein the coupling elements move along with the receiving device.

20. The pipetting device according to claim 16, wherein the main unit comprises a locking element configured to assume a locking position and an open position, wherein a part of the locking element in the fixed position relative to the open position is closer to or further in a spatial pipetting head region occupied by said pipetting head when the pipetting head is received.

21. The pipetting device according to claim 20, wherein the locking element is pre-tensioned into the fixed position and the main unit comprises an release component adjustable in a vertical direction relative to the receiving device, wherein the main unit is configured such that a vertically upward adjustment of the release component relative to the receiving device transitions the locking element from the fixed position into the open position and wherein the release component is arranged such that it can be blocked by a blocking counterpart that is fixedly arranged relative to the storage surface during a vertical movement of the main unit towards the storage surface.

22. The pipetting device according to claim 19, wherein the pipetting device is configured such as to receive the pipetting head
the main unit initially moves in the direction of the storage surface until the locking element is transferred from the fixed position to the open position by a vertically upward adjustment of the release component relative to the receiving device,
then the receiving device is moved in the horizontal engagement direction, and
subsequently, the main unit carries out a lifting movement, in which the main unit is moved upwards in the direction away from the storage surface until the locking element, which is pre-tensioned into the fixed position, has moved back into the fixed position.

23. The pipetting device according to claim 22, wherein
the receiving device comprises further horizontally extending coupling elements above the coupling elements, that are configured such that they can engage in the horizontal engagement direction with further coupling element counterparts of the pipetting head that also extend horizontally or can detach in the opposite direction from these further coupling element counterparts, wherein the further coupling elements are movable in a vertical direction relative to the coupling elements arranged below them,
a further locking element is arranged above the locking element, which is configured to assume locking position and an open position, wherein a part of the further locking element is closer to or further in the area of the pipetting head in the fixed position compared to the open position and the further locking element is pre-tensioned into the fixed position and is transferred from the fixed position to the open position by a movement of the further coupling elements towards the coupling elements arranged below them, and
the main unit is configured to move the further coupling elements independently of, in particular before, the lifting movement of the main unit in a vertical direction away from the coupling elements arranged below them until the further locking element that is pre-tensioned into its fixed position has moved back into the fixed position.

24. The pipetting device according to claim 16, wherein an adapter is arranged on the storage surface for receiving laboratory containers.

25. The pipetting device according to claim 24, wherein the storage surface and the adapter are configured such that the adapter is fixed arranged on the storage surface in the X and Y directions and configured to receive and fix the pipetting head in the X and Y directions.

26. The pipetting device according to claim 21, wherein the adapter comprises the blocking counterpart.

27. The pipetting head configured to be received in a pipetting device according to claim 16, wherein the pipetting head comprises a top and a bottom, a front and a back, and has a right side and a left side, wherein, for receiving in the pipetting device, the front side is directed towards the pipetting device and the back side is directed away from the pipetting device, the top is directed upwards and the bottom downwards, and the left and right sides are respectively directed in directions transverse to the pipetting device, wherein the pipetting head comprises on its left and right side, or on its front and back side, horizontally extending coupling element counterparts, that are configured to engage with the horizontally extending coupling elements of the pipetting device which are matched thereto and move in a horizontal engagement direction, or to detach again from the coupling elements of the pipetting device when the coupling elements move against the horizontal engagement direction.

28. The pipetting head according to claim 27, wherein the pipetting head comprises an upper part and a lower part and is configured such that the upper part can be moved vertically upwards relative to the lower part, wherein the coupling element counterparts are arranged on the lower part and the upper part has further coupling element counterparts on its left and right side, or on its front and rear side, which are configured to engage with horizontally extending further coupling elements of the pipetting device that are matched thereto and move in the horizontal engagement direction, or to disengage again from the further coupling elements of the pipetting device when the further coupling elements move against the horizontal engagement direction.

29. A pipetting set comprising a pipetting device and a pipetting head, wherein:
the pipetting head comprises a top and a bottom, a front and a back, and has a right side and a left side, wherein, for receiving in the pipetting device, the front side is directed towards the pipetting device and the back side is directed away from the pipetting device, the top is directed upwards and the bottom downwards, and the left and right sides are respectively directed in directions transverse to the pipetting device, and
the pipetting head comprises on its left and right side, or on its front and back side, horizontally extending coupling element counterparts, that are configured to engage with the horizontally extending coupling elements of the pipetting device which are matched thereto and move in a horizontal engagement direction, or to detach again from the coupling elements of the pipetting device when the coupling elements move against the horizontal engagement direction.

30. A method for receiving a pipetting head by a pipetting device comprising:
receiving the pipetting head by the pipetting device by movement of the pipetting device in two mutually perpendicular directions.
